(19) United States
(12) Patent Application Publication
(10) Pub. No.: US 2006/0082532 A1
(43) Pub. Date: Apr. 20, 2006

(54) Method for driving an LCD panel

(75) Inventor: Fu-Zhi Chang, Changhua City (TW)

Correspondence Address: Min, Hsieh & Hack, LLP;c/o PortfolioIP, P.O. Box 52050, Minneapolis, MN, 55402, US

(73) Assignee: Toppoly Optoelectronics Corporation

(21) Appl. No.: 11/138,629

(22) Filed: May 26, 2005

Related U.S. Application Data
(60) Provisional application No. 60/619,919, filed on Oct. 20, 2004.

(51) Int. Cl. G09G 3/36

(52) U.S. Cl. 345/87

(57) ABSTRACT

A method for driving an LCD panel is provided. The method includes the steps of providing a scan signal to each of the scan lines during the scan period of each scan line, providing a plurality of panel control signals in a first permutation to the horizontal switch during the scan period of a first scan line, and providing a plurality of panel control signals in a second permutation to the horizontal switch during the scan period of a second scan line, wherein the second permutation is different from the first permutation.

### CROSS-REFERENCE TO RELATED APPLICATION

This application claims the priority benefits of U.S. provisional application titled “Periodic rearrangement driving method and device” filed on Oct. 20, 2004, Ser. No. 60/619,919. All disclosure of this application is incorporated herein by reference.

### DESCRIPTION OF THE DISCLOSURE

1. Field of the Disclosure

The present disclosure relates to a method for driving an LCD panel. For example, the present disclosure relates to a method for driving an LCD panel with different permutations of panel control signals.

2. Background of the Disclosure

FIG. 1 is a schematic diagram showing part of a driving circuit of an LTPS (low temperature polysilicon) LCD (liquid crystal display) panel. The timing controller 101 provides data signals to the source driver 103. The source driver 103 converts the data signals from digital signals to analog signals, and then provides the analog data signals 110 and 111 to the horizontal switches 104 and 105, respectively. The timing controller 101 also provides the panel control signals CKH1-CKH3 to the level shifter 102. The level shifter 102 amplifies the panel control signals CKH1-CKH3 and then provides them to the horizontal switches 104 and 105.

The purpose of the horizontal switches 104 and 105 is to switch the analog data signals 110 and 111 into corresponding pixels of the scan lines of the LCD panel via data lines (R1, G1, B1 and R2, G2, B2) during the scan period of the scan lines. For example, the horizontal switch 104 is driven by the panel control signals CKH1-CKH3. When a low pulse appears on CKH1, the analog data signal 110 is switched to the red sub-pixel of the first pixel of a scan line via the data line R1. When a low pulse appears on CKH2, the analog data signal 110 is switched to the data line G1 to be received by the green sub-pixel of the first pixel of a scan line. When a low pulse appears on CKH3, the analog data signal 110 is switched to the data line B1 to be received by the blue sub-pixel of the first pixel of a scan line. FIG. 2 shows the timing sequence of the panel control signals CKH1-CKH3 in FIG. 1. As shown in FIG. 2, the timing sequence of panel control signals for each scan line is fixed in conventional driving circuits of LCD panels.

The operation of the horizontal switch 105 is similar to that of the horizontal switch 104. The difference is that the horizontal switch 105 switches the analog data signal 111 into the second pixel of a scan line instead of switching the analog data signal 110 into the first pixel of a scan line. There is a data mapping mechanism in the timing controller 101 to ensure the correct data signal appears when a particular panel control signal is low. Although FIG. 1 shows only two horizontal switches, an LCD panel can include at least two horizontal switches.

The driving circuit in FIG. 1 is suitable for low-resolution LCD panels. As the resolution of LCD panels gets higher and higher, horizontal switches are often integrated into larger ones to reduce the number of IC (integrated circuit) chips. FIG. 3 is a schematic diagram showing part of such a driving circuit of a high-resolution LTPS LCD panel.

The horizontal switches in FIG. 3 are larger than their counterparts in FIG. 1. Each of the horizontal switches 304 and 305 is driven by six panel control signals (CKH1-CKH6) and has a fan-out of six data lines. The horizontal switch 304 is connected to the data lines R1, G1, B1, R2, G2, and B2. The horizontal switch 305 is connected to the data lines R3, G3, B3, R4, G4, and B4. However, horizontal switches with more than three data lines have a potential problem of brightness variation. In LCD panels using such horizontal switches, due to the fixed timing sequence (as shown in FIG. 2) and the couple effect caused by parasite capacitance, there will be a slight variation of brightness between two adjacent vertical lines of the same gray level. This problem has an adverse effect upon the uniformity of images displayed on LCD panels. Therefore, it is desirable to have a method capable of solving the uniformity problem for driving large horizontal switches.

### SUMMARY OF THE INVENTION

In various aspects of the disclosure, there is provided a method for driving an LCD panel, comprising: providing a scan signal to each of the scan lines during the scan period of each scan line, providing a plurality of panel control signals in a first permutation to the horizontal switch during the scan period of a first scan line, and providing a plurality of panel control signals in a second permutation to the horizontal switch during the scan period of a second scan line, wherein the second permutation is different from the first permutation.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate various embodiments of the disclosure and together with the description, serve to explain the principles of the disclosure.

FIG. 1 is a schematic diagram showing part of the driving circuit of a low-resolution LTPS LCD panel.

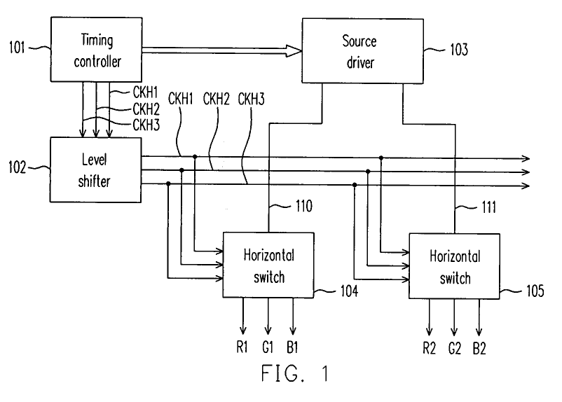

FIG. 2 shows the prior art timing sequence of the panel control signals in FIG. 1.

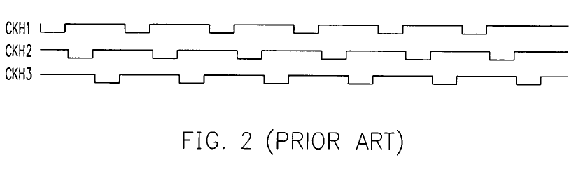

FIG. 3 is a schematic diagram showing part of the driving circuit of a high-resolution LTPS LCD panel.

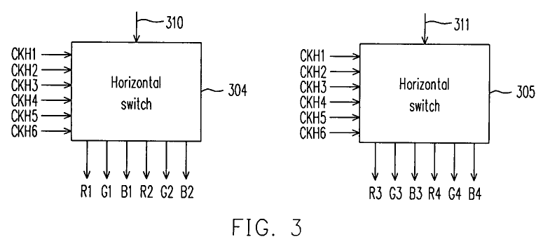

FIG. 4 shows a timing sequence of the panel control signals according to an embodiment of the present disclosure.

FIG. 5 is a flow chart showing the flow of a method for driving an LCD panel according to an embodiment of the present disclosure.

FIG. 6 is a schematic diagram showing an electronic device comprising an LCD panel driven by the method shown in FIG. 5.

### DESCRIPTION OF THE EMBODIMENTS

Reference will now be made in detail to the present embodiments (exemplary embodiments) of the disclosure, an example of which is illustrated in the accompanying drawings. Wherever possible, the same reference numbers will be used throughout the drawings to refer to the same or like parts.

The conventional driving method for LCD panels uses a fixed timing sequence of panel control signals for all scan lines. In contrast, the driving method disclosed herein uses different timing sequences for scan lines immediately next to one another to scatter the variation of brightness.

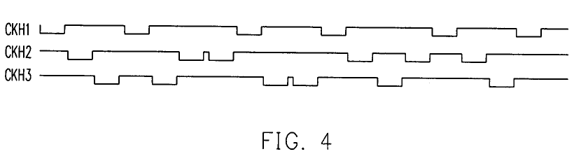

Table 1 shows the timing sequences used in a disclosed embodiment. There may be three panel control signals (CKH1CKH3) in this embodiment, and this embodiment uses six permutations of the panel control signals. A timing sequence may be simply a permutation of the panel control signals. The permutations may be arranged in a cyclic order. For example, scan line 7 may use the same permutation as scan line 1, scan line 8 may use the same permutation as scan line 2, and so on. FIG. 4 shows the same timing sequences in another way.

TABLE 1
an example of timing sequences of three panel control signals

| Scan line | Timing sequence |
|---|---|
| Scan line 1 | CKH1, CKH2, CKH3 |
| Scan line 2 | CKH1, CKH3, CKH2 |
| Scan line 3 | CKH2, CKH1, CKH3 |
| Scan line 4 | CKH3, CKH1, CKH2 |
| Scan line 5 | CKH3, CKH2, CKH1 |
| Scan line 6 | CKH2, CKH3, CKH1 |

Table 2 shows the timing sequences used in another disclosed embodiment. There may be six panel control signals (CKH1-CKH6) in this embodiment. This embodiment may use only 8 permutations out of the 720 possible permutations of the six panel control signals, as can be seen in table 2. The disclosed embodiments do not have to use all possible permutations of panel control signals, as long as the variation of brightness measured by instrument is reduced to a level lower than a predetermined threshold so that the reduced brightness variation can not be discerned by human eyes.

TABLE 2
an example of timing sequences of six panel control signals

| Scan line | Timing sequence |
|---|---|
| Scan line 1 | CKH1, CKH2, CKH3, CKH4, CKH5, CKH6 |
| Scan line 2 | CKH4, CKH2, CKH3, CKH1, CKH5, CKH6 |
| Scan line 3 | CKH1, CKH5, CKH3, CKH4, CKH2, CKH6 |
| Scan line 4 | CKH1, CKH2, CKH6, CKH4, CKH5, CKH3 |
| Scan line 5 | CKH4, CKH5, CKH3, CKH1, CKH2, CKH6 |
| Scan line 6 | CKH1, CKH5, CKH6, CKH4, CKH2, CKH3 |
| Scan line 7 | CKH4, CKH2, CKH6, CKH1, CKH5, CKH3 |
| Scan line 8 | CKH4, CKH5, CKH6, CKH1, CKH2, CKH3 |

In the embodiments discussed above, it may be assumed that panel control signals trigger horizontal switches with logical low pulses. The present disclosure also comprehends embodiments in which panel control signals trigger horizontal switches with logical high pulses.

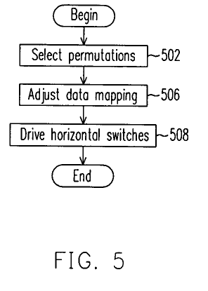

FIG. 5 is a flow chart showing the complete flow of a method for driving an LCD panel according to a disclosed embodiment. The method in this embodiment comprises the following steps.

The method begins at step 502 with selecting at least two permutations among all possible permutations of a plurality of panel control signals. In step 506, the method continues with adjusting a data mapping of a timing controller according to a cyclic order of the selected permutations. The timing controller provides the panel control signals. Moreover, the data mapping may be adjusted according to the permutations to guarantee that the horizontal switches switch the data signals to their corresponding data lines. Moreover, in step 508, the method comprises driving all horizontal switches of the LCD panel with the selected permutations in a cyclic order, wherein each one of the selected permutations may be used for a scan line.

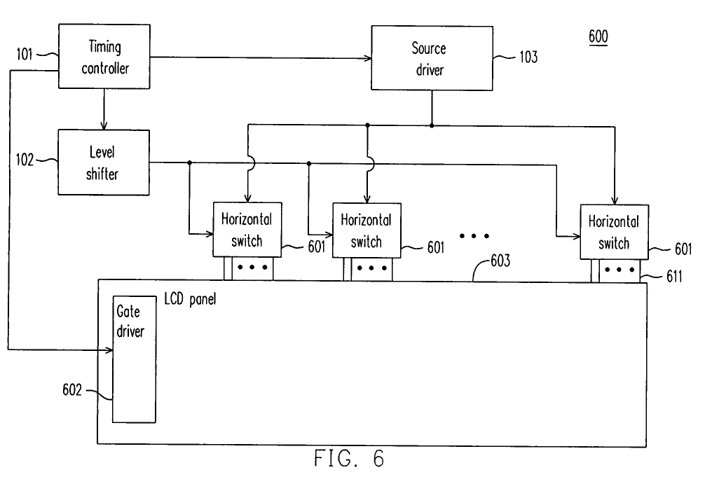

FIG. 6 is a schematic diagram showing the electronic device 600 comprising the LCD panel 603 driven by the method shown in FIG. 5 according to a disclosed embodiment. The electronic device 600 may be a television or a monitor. The electronic device may comprise the timing controller 101, the level shifter 102, the source driver 103, the LCD panel 603, and a plurality of horizontal switches 601. The timing controller 101 may provide data signals to the source driver 103 and may provide gate control signals to the gate driver 602 in the LCD panel 603. The source driver 103 may convert the data signals from digital signals to analog signals, and then may provide the analog data signals to the horizontal switches 601. The timing controller 101 may also provide panel control signals to the level shifter 102. The level shifter 102 may amplify the panel control signals and then may provide them to the horizontal switches 601.

Each of the horizontal switches 601 may receive a plurality of panel control signals and may be connected to one or a plurality of data lines, such as the data line 611. The horizontal switches 601 may allow the analog data signals into the corresponding data lines. The gate driver 602 may convert the gate control signals into scan signals to load the analog data signals into the pixels of the LCD panel 603 during the scan period of each scan line. In some other disclosed embodiments, the level shifter 102 may be incorporated into the LCD panel 603.

As can be seen in the above embodiments, the method for driving an LCD panel disclosed herein may solve the uniformity problem by changing the timing sequence of panel control signals for each scan line. Consequently, the variation of brightness between vertical lines may be scattered among multiple scan lines, so that the brightness variation is smoothed down to a degree that can't be discerned by human eyes.

Other variations of this invention will be apparent to those skilled in the art from consideration of the invention disclosed herein. It is intended that the specification and examples be considered as exemplary only, with a true scope and spirit of the disclosure being indicated by the following claims.

What is claimed is:

1. A method of driving an LCD panel having scan lines and having at least one horizontal switch for sending data signals, comprising:
providing a scan signal to each of the scan lines during a scan period of each scan line;
providing a plurality of panel control signals in a first permutation to the horizontal switch during the scan period of a first scan line; and
providing a plurality of panel control signals in a second permutation to the horizontal switch during the scan period of a second scan line, the second permutation being different from the first permutation.

2. The method of claim 1, wherein the first and the second permutations of the plurality of panel control signals are provided for the scan lines in a cyclic order.

3. The method of claim 1, wherein there are three panel control signals.

4. The method of claim 1, wherein the permutations of the panel control signals for each two adjacent scan lines are different.

5. The method of claim 1, wherein the permutations of the panel control signals for each two adjacent scan lines are the same.

6. A display panel, comprising:
a pixel array including a plurality of scan lines and a plurality of data lines for inputting signal;
a gate driver for providing a scan signal to each of the scan lines during a scan period of each scan line;
at least one horizontal switch for controlling the pass of data signals to the data lines; and
a timing controller for providing a plurality of panel control signals in a first permutation to the horizontal switch during the scan period of a first scan line; and providing a plurality of panel control signals in a second permutation to the horizontal switch during the scan period of a second scan line, the second permutation being different from the first permutation.

7. The display panel of claim 6, further comprising a source driver and the timing controller further providing the data signals to the source driver which in turn sends the data signals to the horizontal switch.

8. The display panel of claim 6, wherein the first and the second permutations of the plurality of panel control signals are provided for the scan lines in a cyclic order.

9. The display panel of claim 6, wherein there are three panel control signals.

10. The display panel of claim 6, wherein the permutations of the panel control signals for each two adjacent scan lines are different.

11. The display panel of claim 6, wherein the permutations of the panel control signals for each two adjacent scan lines are the same.
